(19) United States
(12) Patent Application Publication
(10) Pub. No.: US 2013/0325939 A1
(43) Pub. Date: Dec. 5, 2013

(54) TERMINAL MANAGEMENT SYSTEM AND METHOD FOR MANAGING A TERMINAL

(71) Applicants: Jonghoon Shim, Changwon-si (KR); Minjin Oh, Changwon-si (KR); Hyoungjun Park, Changwon-si (KR); Jongyu Kim, Changwon-si (KR)

(72) Inventors: Jonghoon Shim, Changwon-si (KR); Minjin Oh, Changwon-si (KR); Hyoungjun Park, Changwon-si (KR); Jongyu Kim, Changwon-si (KR)

(21) Appl. No.: 13/985,057

(22) PCT Filed: Apr. 12, 2012
(86) PCT No.: PCT/KR2012/002754

§ 371 Date: Aug. 13, 2013

(30) Foreign Application Priority Data
Apr. 12, 2011 (KR) 10-2011-0033879

(51) Int. Cl. H04L 29/08

(52) U.S. Cl. CPC H04L 67/141
USPC 709/203

(57) ABSTRACT

The present invention relates to a terminal management system and a method for managing a terminal. An embodiment of the present invention relates to a system or an online service in which an original ID is assigned to all terminals, i.e. management targets, and this is registered in a server system in order to remotely receive a management service. Here, the terminal may include various kinds of electronic products, especially, appliances.

### TECHNICAL FIELD

The present invention relates to a terminal management system and a method for managing a terminal. More specifically, the present invention relates to a terminal management system suitable for management of terminals such as electronics sold to consumers and a method for managing terminals. Particularly, the present invention can be adapted for management of electronics such as a washing machine, refrigerator, electric oven, vacuum cleaner, etc.

### BACKGROUND ART

When a washing machine malfunctions, a user has to be provided with after-sale service. Furthermore, the user can only use functions of the washing machine that the washing machine has when purchased and programs for executing the functions installed in the washing machine cannot be updated. Even if the programs are updated, it is inconvenient for the user because update must be performed offline. Moreover, even when firmware or software of the washing machine is updated, the manufacturer cannot inform the user of the update.

### DISCLOSURE

### Technical Problem

An object of the present invention devised to solve the problem lies in a terminal management system and method. Particularly, there is provided a terminal management system and method for managing products such as home appliances.

### Technical Solution

The object of the present invention can be achieved by providing a terminal management system and method capable of remotely managing all terminals corresponding to management targets. The terminals may be electronics, particularly, home appliances.

To remotely manage a terminal by a server system, protocols to perform management services may be respectively installed in the server system and the terminal. That is, a terminal application is installed in the terminal and a server application is installed in the server system. The terminal application and the server application are provided for execution of management services.

A communication environment in which the server system and the terminal are connected to each other may be provided.

An ID (referred to as a device ID) may be assigned to each terminal corresponding to a management target and registered in the server system.

A user ID may also be registered in the server system. A user may register their user ID and device IDs of all terminals used by the user in the server system to be provided with management services.

The server system can recognize a user and terminals used by the user through IDs registered therein and provide a customized service to the user.

Address information for communication, used for the server system to access a terminal or used for the terminal to access the server system may be registered in the server system or the terminal. For example, the address information of the server system can be input to the terminal. When the address information of the server system is not input to the terminal, the user of the terminal may input the address information through a user interface when requesting the server system to provide a service.

A remote management service may be performed in such a manner that a DM server and a DM client operate in association with each other. A mobile communication terminal such as a smartphone may request a management service through an open API of the server system and a service result may be transmitted to the mobile communication terminal and searched.

Part of entirety of the terminal management system and method may be used for a smart grid to reduce energy consumed by home appliances. For example, the terminal management system and method can be used to control a washing machine to be operated in a period of time corresponding to lowest energy cost or to provide hourly power rates to users or home appliances. More specifically, a smart grid application is installed in a washing machine and the server system can transmit smart grid information (e.g. hourly energy cost) to the washing machine. The application can control the washing machine to be operated in a period of time corresponding to low energy cost using the information about the smart grid. Alternatively, the server system may remotely control the washing machine according to the information rather than transmitting the information to the washing machine. In this case, the smart grid related application need not to be installed in the washing machine because remote control can be achieved. Furthermore, the server system may transmit the smart grid information to the washing machine to display the information on a display of the washing machine.

In addition, the terminal management system and method may be used for on-line management services for home appliances, such as diagnosis, monitoring, firmware update, software update (update of software with respect to washing courses in case of a washing machine and update of software including content such as recipes in case of a refrigerator), remote control, etc. Furthermore, it is possible to implement on-line remote control and inquiry with respect to information provided by home appliances, such as a food list (a list of food currently stored in a refrigerator), a shopping list (a list of food that needs to be purchased and stored in the refrigerator), expiration date, etc., improving user convenience.

The object of the present invention can be achieved by providing a terminal management system including: a server to which a user ID and a password generated through a user website are input; and a terminal for transmitting a device ID thereof and the user ID and password (user information) input by a user to the server, wherein the server matches the user ID with the device ID (terminal information) and provides a management service to the terminal at the request of the terminal for the management service.

The terminal may be registered in the server using the user ID, password and device ID provided by the terminal.

The device ID may be previously input to the terminal or automatically generated.

The device ID may be generated in a communication connection procedure prior to registration of the terminal in the server.

The terminal may correspond to home appliances including at least one of a washing machine, a dryer, a refrigerator, a vacuum cleaner and an electric oven.

The terminal may include a user interface configured to request the server to provide a management service, wherein the user ID and password are input through the user interface.

The server may include a user website server for providing the user website and a DM server for issuing a management command to provide a management service to the terminal.

The terminal may provide the device ID and the user ID and password (user information) input by the user to the user website server, and the user website server may match the user ID with the device ID and register the matched user ID and device ID.

The DM server may authenticate and register the user information and terminal information provided by the user website server.

The server may include a DL server providing a function of downloading a file in the terminal and a notification server providing a notification message of the DM server to the terminal.

The terminal may include a communication module for communicating with the server, a DM client executing a management command of the DM server, and a daemon by which the terminal periodically accesses the server.

The communication module may be a WiFi communication module and the terminal is linked to the server through a wireless sharing router (AP).

The wireless sharing router may provide IP information thereof and information on a port to which the terminal is connected to the server.

The terminal management system may further include a mobile communication terminal requesting the server to provide a management service for the terminal through an open application programming interface (API) of the server.

In another aspect of the present invention, provided herein is a terminal management method including: storing a user ID and a password (user information) in a server; transmitting a device ID of a terminal and the user ID and password input to the terminal to the server such that the terminal is authenticated and registered in the server; and after receiving a management service request from the terminal, providing the requested management service to the terminal by the server.

The management service request may be received from a mobile communication terminal instead of the terminal.

The terminal may include a WiFi communication module connected to a wireless sharing router (AP), wherein the wireless sharing router provides IP information thereof and information on a port to which the terminal is connected to the server.

In another aspect of the present invention, provided herein is home appliances including: a WiFi communication module connected to a server through a wireless sharing router; and a user interface configured to request the server to provide management services, wherein a device ID of a terminal and a user ID and a password input by a user through the user interface are transmitted to the server when the management services are requested.

The home appliances may include a washing machine, wherein the management services include at least one of firmware update, software update, remote control of the washing machine and diagnosis or monitoring of the washing machine.

The home appliances may include a refrigerator, wherein the management services include at least one of firmware update, software update, remote control of the refrigerator, food/shopping list management and diagnosis or monitoring of the refrigerator.

### Advantageous Effects

All terminals of a user can be registered in the server system and managed, and thus user convenience with respect to terminals can be improved.

### DESCRIPTION OF DRAWINGS

FIG. 1 illustrates interoperation of a server system, home appliances (terminals) and a mobile communication terminal according to one embodiment.

FIG. 2 illustrates installation of a DM client in a display board of a terminal.

FIG. 3 illustrates interoperation of a main board, a daemon and an agent of a terminal.

FIG. 4 illustrates a user website according to one embodiment.

FIG. 5 illustrates a sign-in and activation procedure according to one embodiment.

FIG. 6 illustrates a withdrawal or service cancellation procedure according to one embodiment.

FIG. 7 illustrates download of an application to a smartphone and request of a terminal management service by a user according to one embodiment.

FIG. 8 illustrates a firmware or software upgrade procedure according to one embodiment.

FIG. 9 illustrates a software management service related procedure according to one embodiment.

FIG. 10 illustrates a remote control service related procedure according to one embodiment.

FIG. 11 illustrates a diagnosis or monitoring service related procedure according to one embodiment.

FIG. 12 illustrates a procedure related to a food management or washing course change service through a backup/restoration management service according to one embodiment.

FIG. 13 illustrates a hierarchical structure of en embedded system in which a DM client/DM daemon of a washing machine is included according to one embodiment.

FIG. 14 illustrates interoperation of applications for terminal management according to one embodiment.

FIG. 15 illustrates a hierarchical structure of en embedded system in which a DM client/DM daemon of a refrigerator is included according to one embodiment.

### BEST MODE

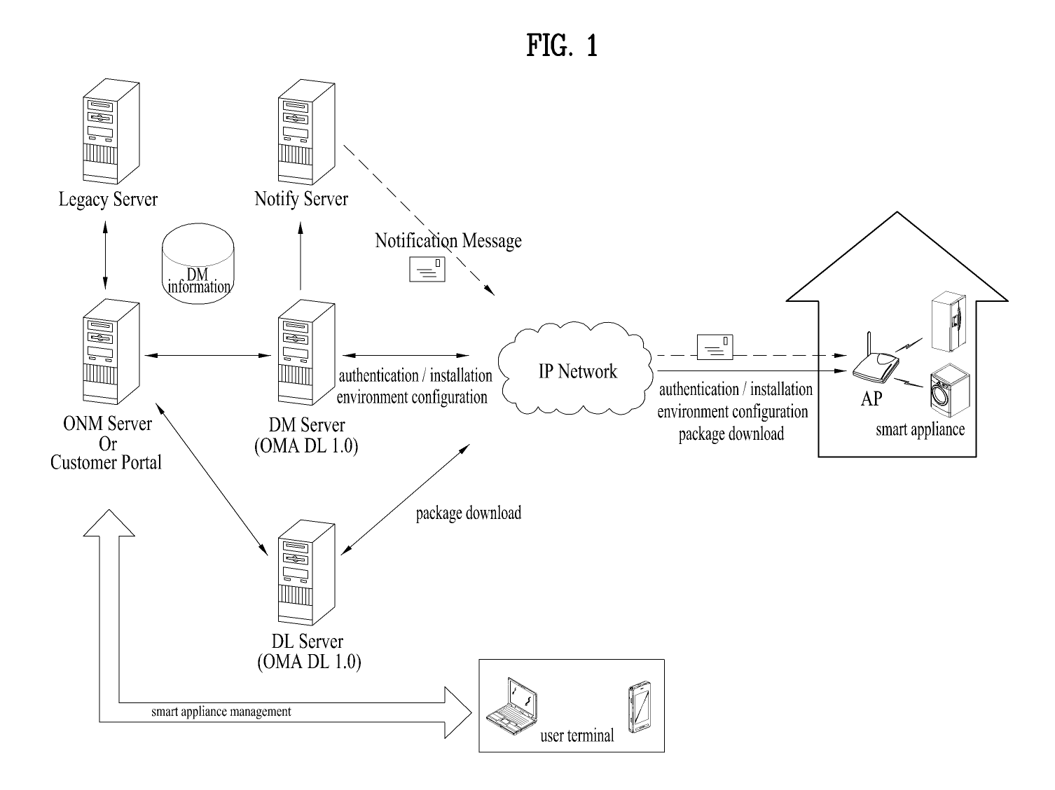

FIG. 1 illustrates a configuration in which home appliances are connected to a server system and managed according to an embodiment of the present invention.

To perform remote control services, a server system for managing home appliances corresponding to management targets is needed. The home appliances corresponding to management targets are connected to the server system to execute commands transmitted from the server system. A service request may be transmitted to the server system through the home appliances. An additional means such as an Internet site (referred to as user website hereinafter) through which a service request is accepted from a user may be provided.

An operator who will manage home appliances may provide the remote management services by constructing the server system. The operator may establish the above-mentioned user website as necessary.

A user may purchase a terminal that can be managed by the server system and be provided with the above-described management services. The terminal may include a communication module for communicating with the server system and a client protocol for executing commands transmitted from the server system. An additional device including the above-mentioned communication module and client protocol may be used for a terminal that cannot be provided with the management services of the server system. The user can be provided with the services by purchasing the additional device and connecting the device to a terminal that cannot be provided with the management services.

Home appliances (terminals) that need to receive the remote management services provided by the server system may be registered in the server system and managed by the server system, having their device IDs.

When home appliances (terminals) access the server system, the server system can identify the appliances through device IDs of the appliances. Characteristic information (e.g. product type, model information, etc.) on home appliances may be registered in the server system in addition to device IDs. The device IDs may be generated irrespective of characteristic information of home appliances. Otherwise, the device IDs may include coded characteristic information of home appliances. Accordingly, the server system can recognize the types or model information of home appliances using only device IDs thereof.

The user may request, to the server system, a service for home appliances registered in the server system and be provided with the service. For example, when the user selects a desired service through a display of a refrigerator, the refrigerator can communicate with the server system to request the service from the server system.

To enable convenient service request of the user and to extend management service items of home appliances, it may be necessary to enable service request through means other than home appliances. When the server system is accessed through home appliances, the server system can identify service targets through device IDs of the home appliances. When the server system is accessed without using home appliances, however, it may be necessary to determine how to identify a service target.

For example, the user can access the user website and request a service by inputting the device ID of a desired appliance. In this case, however, the user needs to memorize device IDs of all home appliances owned by the user.

The user website may be constructed in order solve this inconvenience. The user can sign in to the user website and be assigned a user ID and a password. The user can log in to the user website to register all home appliances owned by the user. Home appliances registered in the user website may be registered along with the user ID in the server system. This may be achieved by automatically transmitting information from the user website to the server system.

Registration of home appliances in the server system may be performed through an activation procedure that will be described later.

In any case, when the user is assigned the user ID, the user ID can be registered along with home appliances of the user in the server system and managed.

A service requested by the user through the user website may be provided when an administrator instructs the server system to provide the service. Otherwise, the user website may be connected to the server system through an open API. In this case, the user can directly request the server system to provide a management service through the user website.

The server system includes the server protocol for management services. The server system performs a requested management service according to the server protocol in association with the client management protocol.

An OMA DM protocol may be used as a protocol for performing management services between the server system and home appliances. Other solutions may also be used. While the OMA DM protocol is used in the present embodiment, the present invention is not limited thereto.

The management services may include the following.

Bootstrap: A DM client of a terminal needs authentication information related to a DM server and network configuration information for network connection to initially perform a management session. A process for this is called bootstraping.

Provisioning: A terminal initially performing a management session is registered in the DM sever through bootstraping and the configuration of the terminal is updated to provide a service to the terminal. This process for this is called provisioning.

Configuration management: A management process for searching and changing terminal related configuration information or setting, searching and changing service relation information is called device configuration management.

Control management: This refers to a management process for controlling a terminal.

User alert: The DM server can inform a user of a management operation through a display of a terminal or be authenticated by sending an alert signal to a DM client of the terminal. That is, improved management can be accomplished through interaction between the DM server and the user.

Diagnosis and monitoring: The performance of a terminal may be deteriorated or the terminal may have a trouble while the user of the terminal is using the terminal. A process for previously recognizing this state and taking a measure suitable for the recognized state to provide a stable product utilization environment to the user is called diagnosis and monitoring.

Firmware update management: This is a process for updating firmware of a terminal when the terminal malfunctions or a function of the terminal is changed after the manufacturer sells the terminal.

Software component management: A process for installing a software component in a terminal, updating the software component and deleting the software component is called software management.

Backup and restoration management: This refers to a process for backing up/restoring data of a terminal in the DM server.

The server system may be distributed to multiple places. For example, server system 1 can be installed in Korea and sever system 2 can be installed in the U.S.

The server system may be divided into multiple servers according to roles. FIG. 1 shows that the server system is divided into a DM server, a notification server, a DL server, an ONM server and a legacy server. In this case, when a specific service is provided, the DM server can prepare or perform other services. Accordingly, a plurality of services can be simultaneously processed.

The servers can directly access targets to execute functions thereof.

Some servers may be configured such that they can directly access home appliances corresponding to service targets. For example, the notification server can directly transmit a notification to target home appliances and the DL server can directly transmit updated firmware to target home appliances.

The server system can be configured based on management services. For example, when only firmware update is provided as a management service, the DM server, notification server and DL server are used and thus other servers are not needed. If services are provided to a user without notifying the user of firmware upgrade, the notification server may not be needed. The configuration of the server system according to management services will be described below with reference to “DM server/client interoperation procedure”. While the server system is configured as shown in FIG. 1 because firmware update, management of software (including content), terminal diagnosis, terminal monitoring, notification of expiration date of food stored in a refrigerator, provision of a food list of the refrigerator, washing course update, etc. are considered in the present embodiment, the present invention is not limited to the server system of FIG. 1.

A description will be given of a configuration of each server of the server system and communication environment in more detail. The following components are not indispensable and other components may be added.

(1) The Server System can be Configured as Follows.

1) DM Server

The DM server issues a terminal management command to a DM client of a terminal. That is, the DM server provides a management function of remotely processing firmware update (modem firmware/OS) management, software management, diagnosis management, etc. through the terminal management command. The DM server may include a session management region, a security management region, a DM protocol process region, a syncML protocol engine region, etc.

2) DL Server

The DL server transmits a file to a DL client. That is, the DL server delivers information about a file to be transmitted to the DL client through a download descriptor (DD) such that the DL client correctly downloads the file. Downloaded files include a firmware update package and a software management package. The DL server may include a session management region, a package management region, a download region, etc.

3) ONM Server or User Portal

The ONM server is interfaced with the DM or DL server and the legacy server and is implemented as a business logic. The administrator can issue a management command through a management webpage of the ONM server or perform management information inquiry.

The user portal provides some functions of ONM to general users. This is implemented through an open API of the DM server. A user can send a management service request to the DM server through the user portal.

4) Legacy Server

The legacy server interoperating with the ONM server includes a server that receives terminal information and a server that receives user information. That is, the legacy server delivers user information or terminal information to the ONM server to provide information for implementing a business logic.

5) Notification Server

The notification server transmits a notification message of the DM server to a terminal. The notification server may include a session generation region, a schedule management region, etc.

If the terminal is present in a private network, the server may need a specially configured connection manager for maintaining connection with the terminal. The terminal can automatically request TCP connection when booted, and the connection manager maintains the requested TCP connection. The DM server delivers the notification message through TCP connection.

6) Open API

Applications of mobile communication terminals such as smartphones can remotely manage terminals through the open API provided by the DM server. The open API will be described in detail below.

(2) A Terminal May Include the Following Components.

1) Communication module

The terminal includes a communication module. The terminal requires the communication module because the terminal needs to be connected to the server system for communication. The type of the communication module is not limited. The communication module may be a wireless communication module or a wired communication module.

For example, the communication module can be a WiFi communication module, a PLC communication module or a ZigBee communication module.

2) DM Client

The DM client executes a management command of the DM server. That is, the DM client provides a management function of remotely processing firmware update management, software management, diagnosis management and control management through the terminal management command of the DM server.

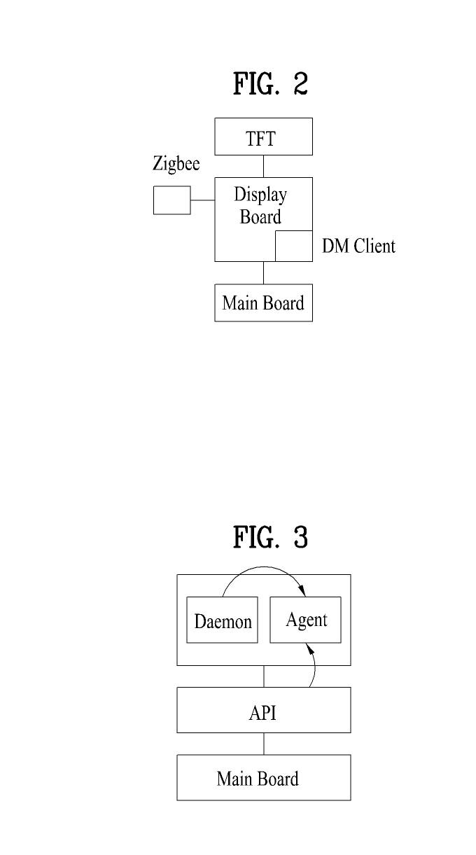

FIG. 2 illustrates a DM client included in a terminal. In case of a terminal including a TFT, the DM client can be mounted on a circuit board (display board) of the TFT. In FIG. 2, a main board is a circuit board for executing functions of the terminal. In case of a washing machine, for example, a main controller for controlling a water feed valve to perform a washing operation and controlling a motor connected to a drum may be included in the main board.

While the DM client can be mounted on the main board of the terminal, it may be advantageous to mount the DM client on the display board since a display window can be frequently used for management service request.

3) DL Client

The DL client downloads package files (firmware update package, software management package, etc) from the DL server. The DL client receives a download server URL from the DM client, accesses a download server using the download server URL to obtain a download descriptor and performs a download operation.

4) Agent

The agent carries out a management service command from a terminal according to management service. For example, an update agent generates new firmware using an update package downloaded for firmware update. The update agent can be implemented in various manners by the manufacturer. FIG. 3 illustrates interoperation of a DM daemon and the agent.

5) Bootstrap

The terminal may include bootstrap information. This will be described in detail below in a bootstrap procedure.

6) Daemon

The daemon processes periodic access of the terminal to the server system. The daemon is preferably kept on unless a power cord is separated from the terminal. For example, when the power cord of the washing machine is connected to a socket even if the washing machine is powered off, the daemon can be kept on. If the washing machine needs to be turned on at the request of the server system, the daemon can transmit a power-on command to the main board of the washing machine.

7) User Interface (UI)

User authentication may be needed to perform a management service and the user may request a management service through the terminal. The user interface can use a TFT LCD window of the terminal. A screen for management services may be displayed on the LCD screen. The management service screen may be configured such that a user ID and a password can be input thereto. The user ID and password may be acquired when the user signs in the user website. When the user requests a service through the terminal, the terminal can transmit the user ID, password, device ID and service request information to the server system.

(3) A Description Will be Given of a Communication Environment of a Terminal and the Server System.

The communication environment is not limited so long as the communication environment is suitable for the above-mentioned management services.

FIG. 1 illustrates communication between the server system and terminals to which a wireless Internet communication module is applied through an AP (access point) via the Internet.

A communication path from the terminals to the AP corresponds to a private network and a communication path from the AP to the server system corresponds to the Internet. The terminals are assigned a private IP from the AP and the AP has a unique IP.

The server system is linked to the Internet through a web server and has a fire wall installed therein, as shown in FIG. 1. The server system is also assigned a unique IP. The web server is provided to protect not only the server system but also other systems. The web server may be regarded as an initial access point connected to the terminals for security. For security, a DNS server may be used. When a terminal attempts to access the server system through the URL of the server system, the DNS server converts the URL into the IP of the server system such that the terminal can access the server system. In this case, the terminal accesses the server system using the URL of the server system.

The DM client of the terminal continuously sends a signal to the DM server such that the server system can locate the terminal. The AP transmits information on a port to which the terminal is connected and the IP thereof to the DM server and thus the DM server can recognize the location of a DL client. When the terminal transmits the device ID thereof to the server system, the server system recognizes the location of the terminal and can access the terminal using the device ID. Here, the user ID and password can also be transmitted to the server system.

To access the server system through the terminal, the IP or URL of the server system may be input to the terminal. When the terminal is present in a private network, the IP of the terminal may not be a unique IP and thus the server system may not access the terminal using the IP of the terminal. Accordingly, the terminal may be configured such that the terminal periodically transmits a signal to the server system, as described above.

(4) Administrator Portal

The administrator portal is not indispensable but can help administrators efficiently perform operations. For example, in case of firmware update, an administrator that updates and registers firmware and an administrator that verifies a registered firmware update file can cooperate with each other through the administrator portal. The administrator portal may include a firmware upgrade process region, a software upgrade process region, a device management region, a system administration region, a statistics region, etc.

(5) Open API

An API category may include “User”, “Diag”, “Mon”, “Content”, “BackupRestore”, “Control”, etc.

“User” is in charge of a user authentication service. “Diag” takes charge of a service for diagnosis request and diagnosis result inquiry. “Mon” takes charge of a service for terminal monitoring request/inquiry. “Content” is in charge of a terminal content information update service. For example, “Content” can take charge of a service for washing machine course information update. “BackupRestore” takes charge of backup/restoration of a food list of a refrigerator, for example. “Control” takes charge of a service for remote control of a terminal such as terminal on/off.

An API list included in “resource identifier” can be configured as follows.

A user list may include user authentication (corresponding to login) and log-out, etc.

A diagnosis list may include diagnosis request, diagnosis request list inquiry, diagnosis result inquiry, etc.

A monitoring list may include monitoring start/end, monitoring result inquiry, etc.

A content list may include a washing machine course update item request, washing machine update request, etc.

A backup and restoration list may include a food list download request, food list upload request, etc., for example.

A control list may include a control list for each terminal. For example, the control list can include washing machine control, refrigerator control, etc.

A common HTTP header may include a user ID. In addition, the header may include a session ID, a terminal type and a device ID.

The user website will now be described in more detail.

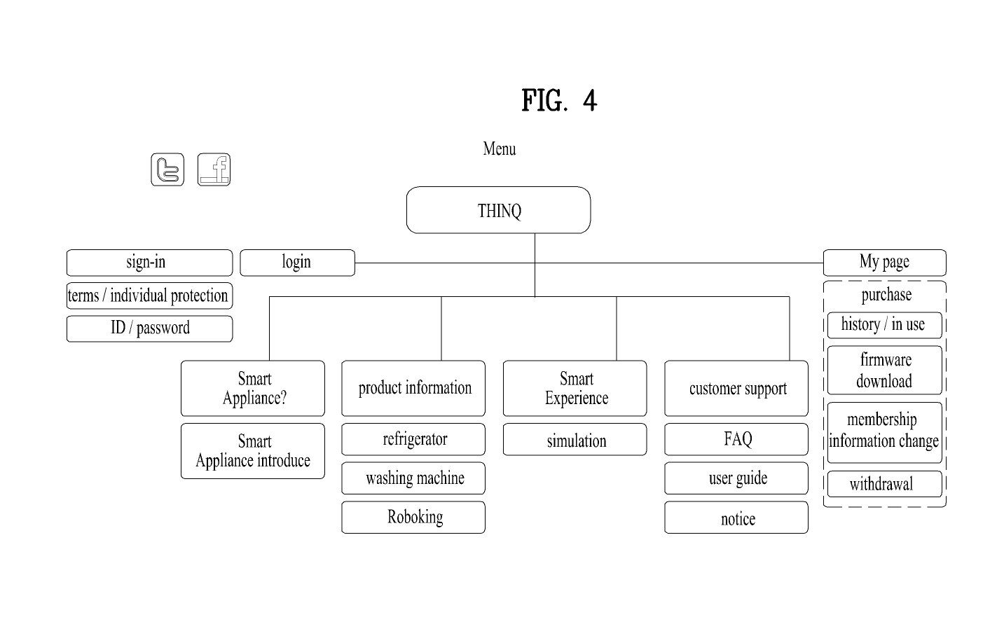

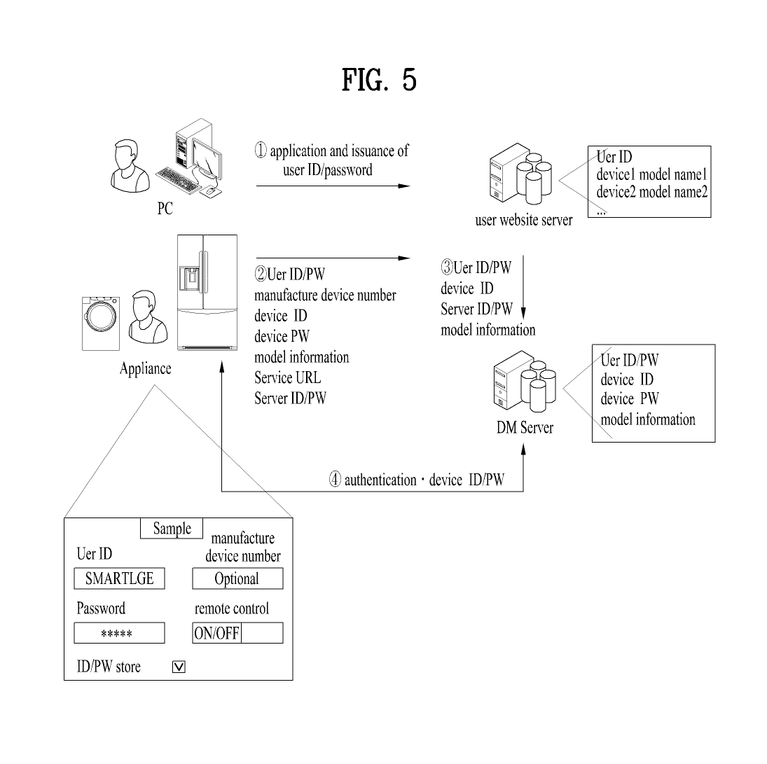

The user website may be generated such that a user can search for information about a management target terminal thereof and request a management service. FIG. 4 illustrates a user website for management services for home appliances. The user website shown in FIG. 4 may include pages such as “sign-in”, “What is a smart appliance?”, “product information”, “smart experience”, “customer support”, “my page”, etc. All the pages need not be provided to the user website. The user website may be configured based on terminal management services and the role thereof. The user website may be configured such that a user ID, password, products that will receive terminal management services can be registered. When registration of products is performed through an activation procedure which will be described later, the user website can include a page through which a user can search the registered products.

The above-mentioned pages may be displayed on the main screen of the user website as a link menu. When the user selects and clicks on a specific menu item, a page corresponding to the specific menu item is displayed. Furthermore, the main screen of the user website may display terminal management service items. For example, “smart grid”, “smart diagnosis”, “smart access”, “smart adapt”, “smart manager”, etc. can be displayed on the main screen. Here, “smart grid” relates to the above-described smart grid related terminal management service, “smart diagnosis” relates to a diagnosis related terminal management service, “smart access” relates to remote terminal control, “smart adapt” relates to management of firmware or software. “Smart manager” relates to backup/restoration of terminals, for example, management of a shopping list or a food list of a refrigerator.

In addition, the user website may include a menu linked to SNS, as shown in FIG. 4. FIG. 4 shows a menu linked to Twitter and Facebook.

Content of the above-mentioned pages shown in FIG. 4 will now be described.

(1) Sign-in

A user can register their user ID and password through sign-in. A sign-in procedure may correspond to a general sign-in procedure performed in other websites and thus detailed description thereof is omitted.

(2) What is a Smart Appliance?

“What is a smart appliance?” may be a page including introductions to terminal management services with respect to home appliances. This page may include explanation of terminal management services that can be provided to home appliances. For example, the page can include explanation of terminal management services that can be provided to a refrigerator, washing machine, electric oven, vacuum cleaner (e.g. Roboking as a robot cleaner shown in FIG. 4), etc.

More specifically, in case of the refrigerator, the user can check information or expiration dates of food stored in the refrigerator through the screen of the display of the refrigerator or can check a shopping list including items that need to be stored in the refrigerator through a smartphone via the “What is a smart appliance?” page. In addition, the user can download a recipe and display the downloaded recipe on the display in case of the electric oven, can operate the washing machine in a most cost-effective time period in association with a smart grid and can remotely instruct the robot cleaner to perform cleaning in case of the robot cleaner via the “What is a smart appliance?” page.

(3) Product Information

“Product information” may include explanation of home appliances to which the terminal management services can be provided. “Product information” may include characteristics of home appliances or specifications of the home appliances. For example, “product information” can include information about model names, capacity, exterior designs, colors, sizes, etc. of home appliances. Furthermore, this page may include explanation of devices available for existing appliances to which the terminal management services cannot be provided. For example, this page can include explanations of devices available for existing appliances in which communication modules or protocols for interoperation with the server system are not installed.

FIG. 4 shows product information with respect to “refrigerator”, “washing machine” and “Roboking”.

In addition, a “Product Information” page may include explanations of appliances to which the terminal management services cannot be provided. Here, information on each appliance can include information representing whether the terminal management services are available or not for the corresponding appliance.

(4) Smart Experience

“Smart Experience” may be a page through which a user can virtually experience the terminal management services. For example, this page may be a space on the Internet in which the user can virtually experience terminal management services provided to the refrigerator, washing machine, Roboking, electric oven, etc. This page may include a space in which the user can virtually experience the terminal management services for each appliance. For example, upon selection of the refrigerator, the user can check terminal management services available for the refrigerator. More specifically, a user interface actually applicable to the refrigerator or a user interface of a mobile communication terminal, which is related to terminal management services, may be displayed. When the user clicks the user interface, virtual implementation of the terminal management services is displayed. For example, when the user wants to check a food list of the refrigerator using a mobile communication terminal (e.g. smartphone), the user presses a food list inquiry button through the displayed user interface. Then, transmission of food list information stored in the refrigerator or food list information stored in the server system and inquiry of the information through the user interface can be displayed.

In addition, a “Smart Experience” page may be configured such that a virtual experience of a smart grid with respect to the washing machine is possible. For example, a user interface of the washing machine, which includes a button related to the smart grid, can be displayed and operation of the washing machine related to the smart grid can be displayed when the user clicks the button. Operation related to the smart grid is as described above.

A simulation may be a simulation for a user interface of each appliance. That is, the same image as a UI displayed on the LCD screen of each appliance can be displayed as the screen of the simulation. This simulation may be adapted for a user guide related to terminal management services for each appliance.

A description will be given of embodiments of the above-described simulation. The simulation may include a simulation related to the terminal management services and a simulation for experiencing functions of appliances.

(5) Customer Support

“Customer support” may include sub-pages such as “FAQ”, “user guide”, “notice”, etc. “Customer support” page may include not only information about use of the user website but also information regarding the terminal management services. This page may be configured in a question-and-answer form. Furthermore, when there is a notice from the administrator or manufacturer, such as “notice”, the “customer support” page may be configured such that the notice is posted.

“User guide” may include explanation of a procedure for receiving a terminal management service. For example, “user guide” can include explanation of a procedure for issuing an ID and a password through subscription and then registering products. In addition, this page may include explanation of download of smartphone applications. Furthermore, “user guide” may include explanations of a service scenario related to the terminal management services, images of smartphone applications related to the services, display images of appliances related to the service, etc. Moreover, this page may include explanations of the images.

(6) My Page

“My page” may be a private page of a user who logs in. This page may include content regarding appliances registered for the terminal management services. For example, “my page” can display a list of registered appliances. The list of registered appliances may include product names (e.g. refrigerator, washing machine, etc.), model names of the appliances, etc. In addition, this page may include display of whether terminal management services are currently used for registered appliances. Furthermore, “my page” may be configured such that the user can stop terminal management services for registered appliances.

A list of appliances registered for a specific user may display product names (or product types), model names, etc.

Terminals requiring management services, that is, appliances of a user can be registered through the activation procedure which will be described later. A method through which the user can directly register their terminals in the user website may be considered. That is, the user website may include a page regarding terminal registration such that the user directly registers their terminals through the page. When the user directly registers the terminals, information for registration may correspond to information used in the activation procedure described below.

“My page” may include information about firmware update with respect to registered appliances. In addition, “my page” may also include information representing whether firmware of registered appliances is updated. This information may include the file name or version information of updated firmware and information on the date when the firmware is updated. Furthermore, “my page” may include information representing whether or not the user has updated or downloaded their appliances. Moreover, “my page” may include a user request for downloading updated firmware or installing the updated firmware in appliances of the user. Here, the request for installing the updated firmware in the appliances may correspond to a request for a terminal management service related to firmware update. For example, “my page” can include a request for a terminal management service for update firmware and, when the user selects the request, the request can be transmitted to the server system. The server system may update the selected firmware in association with the corresponding appliances.

In addition, “my page” may include content regarding withdrawal of membership. “My page” may display a page for withdrawal, which can display an alert massage representing that terminal management services cannot be provided any more if the user withdraws membership. The page may display a list of appliances registered with respect to the user along with the alert message.

The above description of the user website is exemplary. That is, “sign-in”, “What is a smart appliance?”, “product information”, “smart experience” and “my page” are exemplary and the present invention is not limited thereto. The user website may be configured to include all or some of the above-described components irrespective of the terms used in the above-described embodiment.

A description will be given of content and procedures of management services.

(1) Subscription and Terminal Activation

FIG. 5 illustrates subscription and terminal activation.

As described above, the user can access the user website and sign in to the user website to be assigned a user ID and a password.

Terminal activation may be a procedure for registering a user terminal in the server system. The display of the terminal can display a window to which the user ID and password can be input and the user can perform the activation procedure through the displayed window. When the user inputs the user ID and password to the displayed window and then inputs an activation command, the terminal transmits the user ID, password, device ID and characteristic information thereof to the user website. Here, the input user ID and password can be stored in the terminal, and thus the user ID and password can be used to authenticate the user.

The device ID may be previously input to the terminal or automatically generated when the activation procedure is performed. Otherwise, the device ID may be automatically generated when the terminal is purchased and initially turned on.

The characteristic information of the terminal may include model information, a product code, manufacture date, production serial number, etc. of the terminal.

In the activation procedure, the terminal may transmit a terminal password, service URL, server ID and password. Information other than the user ID and password transmitted to the user website in the activation procedure may be automatically generated in the terminal or previously input to the terminal.

Upon transmission of the above-mentioned information from the terminal to the user website through the activation procedure, the user website registers the terminal with the user ID. Accordingly, terminals used by users are registered by user IDs in the user website.

The user website transmits the user ID, password, device ID and the characteristic information of the terminal to the server system. Here, the server ID and password may also be transmitted.

The server system authenticates the transmitted information. Upon successful authentication of the information, the user ID, password, device ID and device characteristic information are registered in the server system. Here, the device password may also be transmitted.

The activation procedure can be performed in any environment where the server system and the user website can be accessed. For example, the activation procedure can be performed in a place where a terminal is purchased.

The user may cancel registration of their terminal. When the user displays a screen for cancellation of registration on the display of the terminal, inputs the user ID and password and inputs a registration cancellation command, the terminal accesses the user website or the server system and transmits information about registration cancellation to the user website or the server system. Then, the user website or the server system cancels registration of the terminal.

The user may withdraw the user website. Upon withdrawal of the user, registration of terminals belonging to the user and registered in the server system is cancelled.

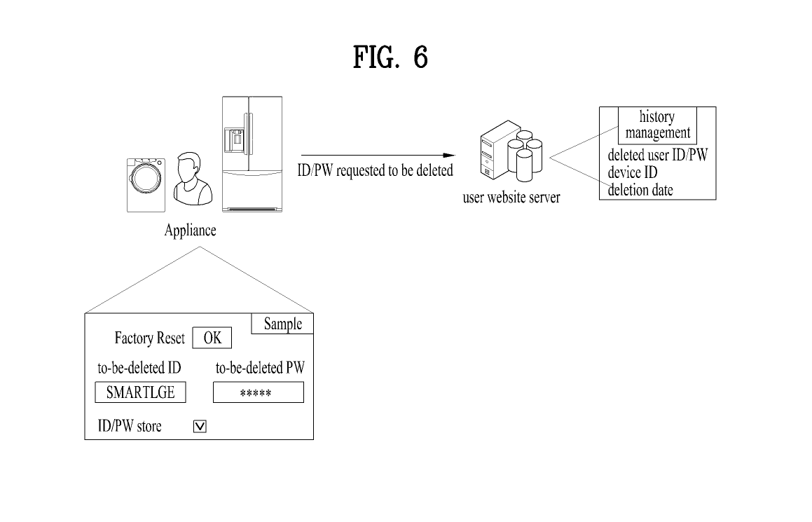

FIG. 6 illustrates a procedure through which the user requests deletion of their user ID and password through the terminal. When the user inputs the user ID and password to be deleted through the display of the terminal, the user website or the server system can cancel registration of information on the user and terminals belonging to the user.

(2) Service Request of User

The user can request a service through a display of a terminal that requires the service. For example, the user can display the screen of the desired service on the display of the terminal, input the user ID and password to the screen and then request the service. Here, the terminal can transmit the user ID, password and device ID in addition to information about the request.

Furthermore, the user may request a desired service through the user website. The user website may provide a webpage through which the user can request a desired management service. The user website can transmit information about service request to the server system at the request of the user for the service. Here, the user ID, password and device ID can be simultaneously transmitted.

The user may call a call center to request a service. The call center may have an ARS system to accept management service requests.

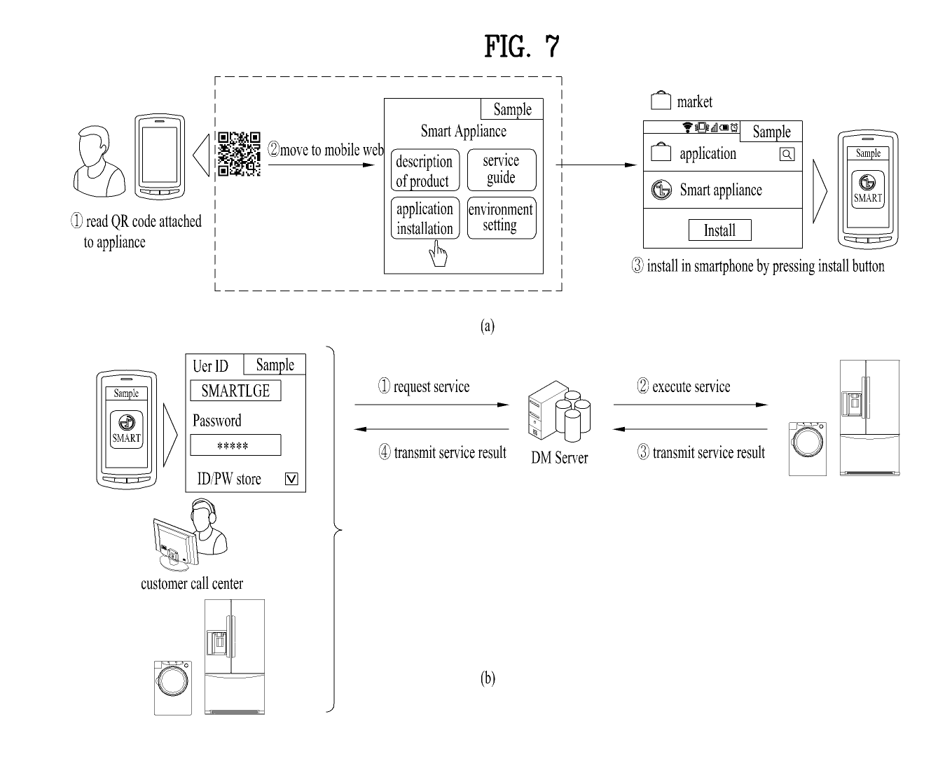

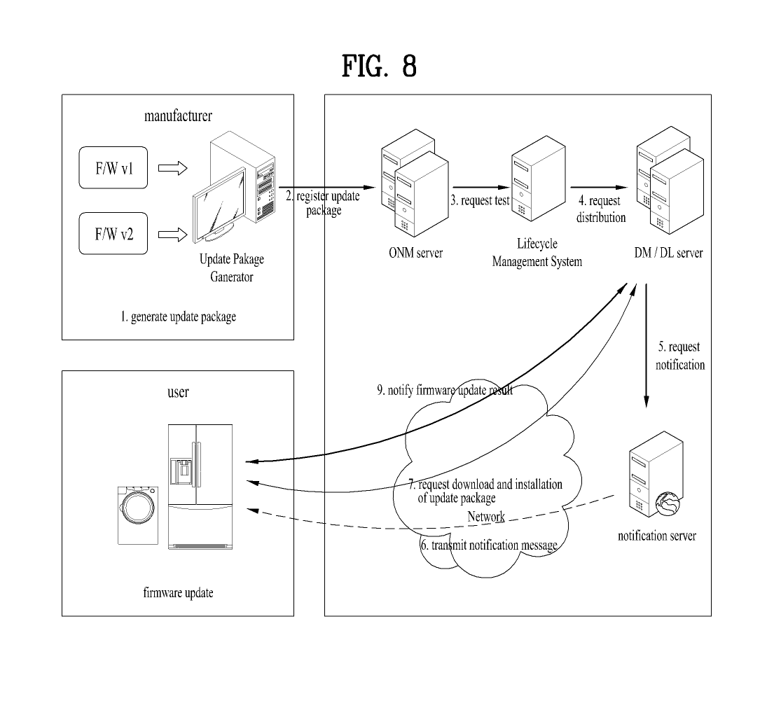

The user may request a service through a mobile communication terminal such as a smartphone. FIG. 7(a) illustrates download of a smartphone application for management services and FIG. 7(b) illustrates request of services through a smartphone, the call center and terminals (washing machine and refrigerator in this example).

When the user requests a service through the smartphone, the user can request the service by initiating a management service application installed in the smartphone and then inputting the user ID and password. The smartphone can transmit information about the request to the server system to request the server system to provide the service and may transmit the user ID, password and device ID along with the information.

(3) Firmware Update

Firmware update is a service for correcting errors generated when the manufacturer of the terminal developed the terminal. A firmware update package can be generated through an update package generator of the manufacturer and the generated update package is transmitted to the corresponding terminal through the DM/DL client.

The update package delivered to the terminal can be stored in a reserved address of a predetermined flash memory. Here, the size of the update package can be limited by the manufacturer or operator.

A procedure for updating the firmware update package is illustrated in FIG. 8. This procedure will now be described with reference to FIG. 8.

1. Update package generation: The manufacturer generates new firmware when firmware is changed. An update package in which a difference between the new firmware and the firmware of the current version is recorded is generated.

2. Update package registration: The manufacturer registers the generated update package in the system of the operator.

3. Test request: The registered update package performs a self-test prior to being transmitted to the terminal.

4. Distribution request: The update package that has passed the self-test is registered in the DL server for distribution to the terminal.

5. Notification request: The DM server requests notification message transmission in order to perform a registered operation.

6. Notification message transmission: T notification message is transmitted to the terminal.

7. Update package download and installation request: The terminal that has downloaded the update package is re-started (the terminal may be updated before restarting as necessary).

8. Firmware update: The terminal performs update using UA.

9. Firmware update result notification: The terminal notifies the DM server of the firmware update result.

The DM client of the terminal interoperates with the DM server using the OMA DM protocol and firmware update is performed according to interoperation of the DM client of the terminal and a FUMO agent.

The DM server and the user start the firmware update procedure and a DM session mode can support background and foreground.

When the firmware update procedure is started by the DM server, the firmware update procedure can be started upon transmission of a notification message from the DM server to the DM client. Here, download and update can be simultaneously performed. That is, the update package file can be downloaded and then update can be immediately performed through UA (FUMO node: DownloadAndUpdate).

When the firmware update procedure is started by the user, the user can input FUMO node (DownloadAndUpdate) through a menu item displayed on the display of the terminal.

(4) Software Management

Software management is a process for adding, updating and deleting software. User software may be installed in a file system region (including internal/external memory) of the terminal.

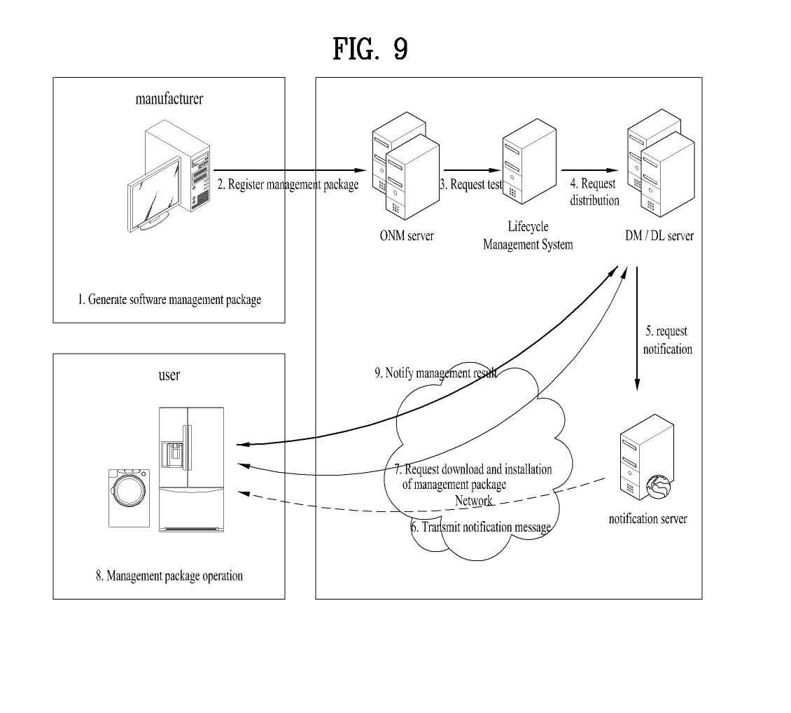

A software management procedure is illustrated in FIG. 9. A push type service can be provided using the software management procedure. The procedure shown in FIG. 9 will now be described.

1. Software management package generation: A software manufacturer develops software and generates a management (distribution) package suitable for a corresponding OS.

2. Management package registration: The software manufacturer registers the generated management package in the server.

3. Test request: The generated management package is tested.

4. Distribution request: Distribution of the tested management package is requested.

5. Notification request: The DM server requests notification message transmission in order to perform registered operation.

6. Notification message transmission: A notification message is transmitted to the terminal.

7. Management package download and installation request: The DM server requests the DM or DL client to download and install the management package.

8. Management package operation: The downloaded management package requests a corresponding OS installer to install the management package having a desired option according to a SCoMO agent and the OS installer installs/updates the management package in a user file system region.

9. Management result notification: The DM client of the terminal notifies the DM server of a management result.

The DM client of the terminal interoperates with the DM server using the OMA DM protocol and software management is performed according to interoperation of the DM client of the terminal and a SCoMO agent.

A software management procedure may be initiated by the DM server and the DM session mode can support both background and foreground. The software management procedure can be started upon transmission of a notification message from the DM server to the terminal. Here, download and update can be simultaneously performed. That is, a management package file is downloaded and then management (SCoMO node: DownloadInstallInactive or DownloadInstall) is immediately performed through the SCoMO agent.

(5) Terminal Control Management (Product Control)

A terminal can be remotely controlled. Control management may be initiated by the DM server and performed in the background. Accordingly, an interaction with the user through MMI and generation of interrupt is not considered.

In case of the refrigerator, a refrigeration compartment temperature, freezer temperature, convertible room temperature or mode (frozen food mode, meat mode, vegetable mode, etc.), special freezing control (including on/off), refrigerator operation mode control (crushed ice mode, water mode, ice cube mode, etc.), etc. may be control items. In case of the washing machine, power on/off, execution of operation, interruption of operation, etc. may be control items. Control management is performed through the DM server using a smartphone application via the open API.

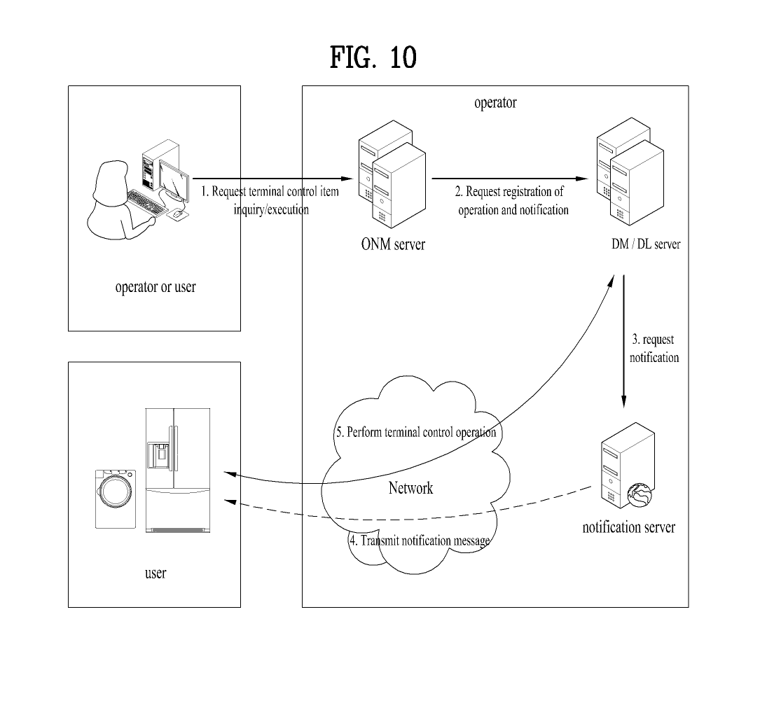

A procedure for control management is described in detail with reference to FIG. 10.

1. Control item search/execution request: The administrator (user) requests the ONM server to perform control item search/execution operation using a management screen of the ONM server.

2. Operation registration and notification request: The ONM server requests the DM server to perform control/execution operation and notify the terminal through a notification message.

3. Notification request: The DM server requests the notification server to notify the corresponding terminal.

4. Notification message transmission: The notification message is delivered to the terminal.

5. Control operation execution: The terminal accesses the DM server to perform control operation upon reception of the notification message from the DM server.

The DM client of the terminal interoperates with the DM server using the OMA DM protocol and control management is performed according to interoperation of the DM client of the terminal and a control agent.

Control management may be initiated by the DM server and the DM session mode may be background. Control management is started upon transmission of the notification message from the DM server to the DM client.

(6) Diagnosis

Diagnosis is a service for diagnosis of the terminal. For example, when the user believes that the washing machine malfunctions, the user can request the diagnosis service. The washing machine can start a diagnosis program to collect data necessary for diagnosis upon issuance of a diagnosis command.

The terminal may collect event data or log data during operation. This data can be used as diagnostic data. That is, diagnostic data can be collected even when a diagnosis request is not present. For example, when an event that the drum of the washing machine is not rotated is generated, data regarding this event can be recorded and stored. Accordingly, when the user requests diagnosis, data collected and recorded so far and data collected by executing the diagnosis program may be transmitted to the server system.

In case of the washing machine, diagnostic data may include the percentage of actual working time of the motor, power applied to the washing machine, internal temperature of the tub or drum, data related to operation of the water feed valve, data related to operation of a drain valve, etc. In case of the refrigerator, the diagnostic data may include data related to operation of a cooling fan, temperature of the refrigeration compartment or freezer, data related to operation of a compressor, data related to operations of valves including an expansion valve, data related to operation of an icemaker, etc.

In addition, the diagnostic data may include data related to operation of a display or an input unit corresponding to a user interface, data related to operations of various sensors such as a water level sensor (in case of the washing machine), temperature sensors (e.g. a sensor for sensing the internal temperature of the tub of the washing machine, a temperature sensor of the refrigeration compartment or freezer of the refrigerator, etc.), etc.

The diagnostic data may include information about a command execution time and a data generation time. The diagnostic data can be transmitted to the server system and the server system can produce a diagnosis result by executing an analysis program.

Diagnosis may be requested through a smartphone. Otherwise, the customer center may request the server system to provide the diagnosis service at the request of the user. When an error is generated in the terminal, the terminal transmits information about the error to the server system such that diagnosis can be performed.

An interface of the open API for diagnosis can be designed such that only a start interface is provided, and thus diagnosis may not be interrupted once diagnosis is started.

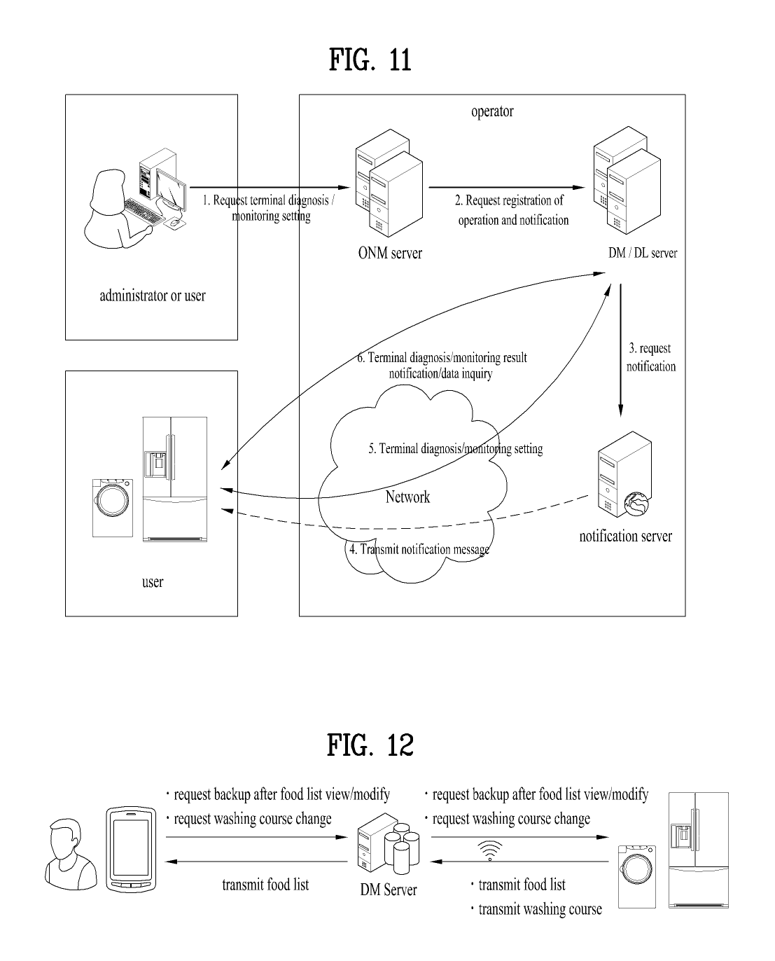

FIG. 11 illustrates a diagnostic procedure. Since the diagnostic procedure may correspond to a monitoring procedure which will be described later, the diagnostic procedure and the monitoring procedure are illustrated together in FIG. 11.

1. Diagnosis/monitoring request: The administrator (or user) requests diagnosis/monitoring through a management screen of a diagnosis server.

2. Operation registration and notification request: The management server requests execution of diagnosis/monitoring and notification to the DM server.

3. Notification request: The DM server requests the notification server to alert the terminal.

4. Notification message transmission: The notification server transmits a notification message to the terminal.

5. Diagnosis/monitoring setting: The DM server requests the DM client to start diagnosis/monitoring.

6. Diagnosis/monitoring result notification/data inquiry: The DM client (DiagMon Agent) of the terminal notifies the DM server of a diagnosis/monitoring result (sends an alert message) upon completion of diagnosis/monitoring.

Diagnosis/monitoring may be initiated by the DM server or the user and the DM session mode may be background.

When diagnosis/monitoring is started by the DM server, diagnosis/monitoring is started upon transmission of the notification message from the DM server to the DM client. When diagnosis/monitoring is started by the user, the user starts diagnosis/monitoring through the display screen and the terminal executes the DM client upon completion of terminal diagnosis/monitoring.

Diagnosis according to another embodiment is described. This embodiment relates to a process through which the user transmits operation sound of the terminal to the server system. For example, the user can transmit sound generated when the terminal is operated to the server system through a mobile communication terminal. The server system can diagnose the terminal by analyzing the operation sound. The user can transmit the operation sound to the server system through various methods. For example, the user calls the service center and transmits the operation sound of the terminal through the receiver of the mobile communication terminal. Then, the service center can transmit the operation sound to the server system. The service center may include an ARS system for automatically transmitting the operation sound. Furthermore, the user may use a mobile communication terminal (e.g. smartphone) in which a diagnosis program is installed. That is, the operation sound can be transmitted to the server system using the diagnosis program. In this case, the operation sound may be directly transmitted to the server system or transmitted to the user website such that the user website delivers the operation sound to the server system. The server system may include a program for analyzing the operation sound and performing diagnosis based on the operation sound. This program can analyze sound data of the operation sound and convert the sound data into an error code or status information. This diagnosis result can be transmitted to the mobile communication terminal of the user or to the terminal.

(7) Monitoring

Monitoring is a service with respect to monitoring of the terminal. When monitoring is requested, the terminal can transmit monitoring data to the server system.

For example, when the washing machine is requested to provide monitoring data, the washing machine can start a monitoring program to collect monitoring data and transmit the monitoring data to the server system. Here, the monitoring data may include a monitoring command execution time and monitoring data generation time. When execution of monitoring is requested, monitoring data can be repeatedly transmitted upon start of monitoring.

In case of the refrigerator, special freezing state, hygiene filter state (e.g. on or auto state), refrigerator operation mode, dispenser state, error state, door open or close state, etc. may be included in monitoring items. In the case of a washing machine, operation state, remaining time of an operating course, initial set time, washing course type, rinsing level, spin-dry RPM, temperature set for a course, reserved washing time, etc. may be included in monitoring items.

The monitoring service can be requested through a smartphone and a monitoring result can be inquired.

An open API interface for monitoring may be designed such that both start and end interfaces can be provided.

A monitoring procedure may be as shown in FIG. 11.

(8) Backup/Restoration

It is possible to back up/restore user data (e.g. a recipe related file, a shopping list file, a food list file, content files, etc.) of terminals. Backup/restoration can be performed at the request of a terminal and user data can be stored in a corresponding DB through the DM server. The user data can be stored in the corresponding terminal or the server system and updated according to backup/restoration management.

The DM client of the terminal interoperates with the DM server using the OMA DM protocol and backup/restoration management is performed according to interoperation of the DM client of the terminal and a backup/restoration agent.

Backup/restoration management may be started by the DM client and the DM session mode may be executed in the background.

When backup/restoration management is started by the terminal or the user, the terminal (or user) requests backup/restoration for a backup/restoration target and the DM client delivers a corresponding alert message to the DM server.

The backup/restoration management service can be used for a washing course upgrade service in case of the washing machine. For example, when a washing course change request is transmitted to the server system, the server system can transmit data regarding the corresponding washing course to the washing machine.

Food management of the refrigerator may be configured to perform a service such as notification of a food list, shopping list, expiration date, etc.

The food management can handle the food list or shopping list in connection with a smartphone application via the DM server. A service scenario for this operation is as follows.

A. Food management of the refrigerator and the DM server

1. An application of the refrigerator is executed (food management software executes the application).

2. The food management requests a food list to the DM server via the DM client (final data is displayed if the network is not activated).

3. The food management displays the food list received from the DM server through the DM client.

4. The user operates the food list on the food management.

5. The food management delivers the operated food list to the DM server via the DM client.

6. Operation is ended.

B. Smartphone application and DM server

1. A smartphone application is executed (food management software executes the smartphone application).

2. The user logs in using the user ID and password

3. The food management requests the DM server to provide the food list through an open API.

4. the food management displays the food list received from the DM server through the open API.

5. The user operates the food list on the food management.

6. The food management delivers the operated food list to the DM server through the open API.

7. Operation is ended.

FIG. 12 illustrates a backup/restoration management service provided through a smartphone and a terminal.

As shown in FIG. 12, the terminal can request a management service and the server system can provide the management service requested by the terminal. Here, the management service may be requested by a mobile communication terminal instead of the terminal.

A description will be given of interoperation of the DM server and DM client. An interoperation procedure includes a bootstrap process, a notification process, a firmware update process, a software management process, a control management process, a diagnosis management process, a backup/restoration process, etc.

(1) Bootstrap Process

The bootstrap process is performed differently according to customized bootstrap and server initiated bootstrap. In case of customized bootstrap, bootstrap information is defined in terminals and thus the terminal manufacturer performs the bootstrap process on terminals before selling the terminals.

In case of server initiated bootstrap, when a user purchases a terminal and connects a network, the DM server performs the bootstrap process.

The DM client can support customized bootstrap.

Information necessary for bootstrap may include an application ID, DM server ID, DM server name, DM server address, authentication type, device ID, DM server authentication information, terminal authentication information, etc.

The application ID refers to a DM application ID defined in OMA DM.

The DM server ID and DM server name may be needed since plural servers may be present. For example, a server system can be constructed in Korea and a server system can be constructed in the US. The DM server name is a server name for the administrator. Accordingly, the DM server ID and name may not be necessary.

The DM server address corresponds to a DM server address that the DM client will access and information on a port to which the DM client will be connected.

The authentication type corresponds to a security type for authentication information handled during communication between a terminal and a server, and MD5 authentication may be used.

The DM server authentication information may include an ID, password and initial nonce used for the terminal to be authenticated by the server.

The terminal authentication information may include an ID, password and initial nonce used for the terminal to authenticate the server.

Values of the above-mentioned information are not simultaneously determined. Particularly, the device ID and terminal authentication information may be determined after a corresponding terminal is put on the market. The device ID is determined when the corresponding terminal is initially turned on or determined during the activation procedure, as described above. The authentication information may also be determined during the activation procedure.

(2) Notification Process

The DM server transmits a trigger message for a management session through a listening port (UDP or TCP) of a terminal. If the terminal uses a private IP or traffic of the DM server needs to be distributed, the following process can be performed.

\textcircled{1} Case in which a connection manager is specially constructed at the server: the daemon of the terminal requests and maintains a TCP connection after booting the terminal.

\textcircled{2} Case in which the DM client is periodically connected: the daemon of the terminal attempts periodic connection using a predetermined value (defined in a device detail node).

A notification message is present in a WAP push form and an OMA DM notification message is included in a WAP push data region. Here, application/vnd.syncml.notification(0x44) is used as a content type in a WAP WSP region and thus the daemon included in the terminal can recognize the notification message.

(3) Firmware Update Process

An update package is downloaded using OMA DL v1.0. A download descriptor used in OMA DL may include elements such as a type (MIME type of Media Object), size (size of Media Object), objectURI (URI for download of Media Object), installNotifyURI (URI for indicating Media Object download results), nextURI (URI browsed after download operation), DDVersion (version of the download descriptor), name (name of Media Object), description (description of Media Object), vendor (vendor of Media Object), infoURI (additional URI for describing Media Object), iconURI (URI of ICON), installParam {parameter information about installation of Media Object, MD5Value=[Value]: for verifying integrity of download package, FileName=[Name]: name of a downloaded file (used when necessary for the DM client)—the server must deliver the file name at all times unless the downloaded file is firmware}, etc.

The DL server and the DL client use type, size objectURI, installNotifyURI elements.

(4) Software Management Process

Software management relates to addition/update/deletion of software.

1) Software management initiation agent
DM server: The DM server indicates presence of an update item using a notification message and starts management with user's consent as necessary.

2) Software content management initiation agent
DM server: The DM server indicates presence of an update item using a notification message and starts management with user's consent as necessary.
Terminal (user): The user requests software content update through the screen of the terminal.

For software content update, the DM client transmits a request message to the DM server.

(5) Terminal Control Management Process

Terminal control management may be started by the DM server. The DM server can notify presence of a terminal control item using a notification message.

(6) Diagnosis/Monitoring Management Process

Diagnosis/monitoring management can be started through three methods.

a. Initiation by a smartphone (diagnosis/monitoring data)

\textcircled{1} A smartphone application requests start of diagnosis/monitoring.

\textcircled{2} The DM server requests the DM client to start diagnosis/monitoring.

\textcircled{3} The DM client requests a diagnosis/monitoring agent to start diagnosis/monitoring.

\textcircled{4} The diagnosis/monitoring agent collects diagnosis/monitoring data.

\textcircled{5} The diagnosis/monitoring agent stores data in a report server.

\textcircled{6} The report server notifies the DM server.

\textcircled{7} The DM server transmits data to the smartphone application. Alternatively, the user can access the DM Server using the smartphone through the open API to inquire a diagnosis/monitoring result.

b. Initiation by an administration portal (diagnosis/monitoring data)

\textcircled{1} The administration portal requests diagnosis/monitoring to be started.

\textcircled{2} The DM server requests the DM client to start diagnosis/monitoring.

\textcircled{3} The DM client requests a diagnosis/monitoring agent to start diagnosis/monitoring.

\textcircled{4} The diagnosis/monitoring agent collects diagnosis/monitoring data.

\textcircled{5} The diagnosis/monitoring agent stores data in the report server.

\textcircled{6} The report server notifies the DM server.

\textcircled{7} The DM server transmits data to the administration portal.

c. Initiation by the Terminal (LCD) (Diagnosis/Monitoring Data)

\textcircled{1} The user executes the diagnosis/monitoring agent on the display of the terminal.

\textcircled{2} The diagnosis/monitoring agent collects diagnosis/monitoring data.

\textcircled{3} The diagnosis/monitoring agent executes the DM client.

\textcircled{4} The DM client notifies the DM server of a diagnosis/monitoring result through an alert message.

\textcircled{5} The DM server acquires diagnosis/monitoring data and stores the diagnosis/monitoring data in the report server.

(7) Backup/Restoration Management Process

Management of a food list or a shopping list through the backup/restoration management process has the following three interoperation points.

a. Interoperation of the DM Server and a Smartphone Application (Food Management)
Processing through the open API of the DM server

b. Interoperation of the DM Client and the DM Server
Use of the OAM DM protocol

c. Interoperation of the DM Client and a Terminal (Refrigerator) Application (Food Management)
Processing through calling of an interface of the DM client

A description will be given of DM client API standards for the washing machine or refrigerator corresponding to a DMS management service target.

(1) Washing Machine—Interface Between an Embedded System and the DM Client and DM Daemon.

A method of interfacing the embedded system with the DM client/DM daemon of the washing machine will be briefly described.

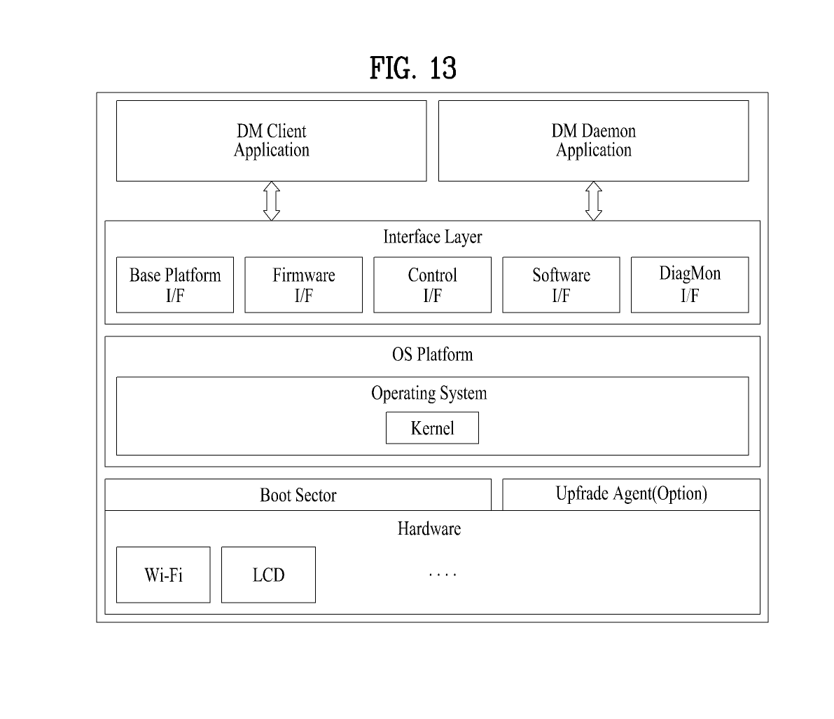

A hierarchical structure of the embedded system including the DM client/DM daemon of the washing machine is shown in FIG. 13. The structure of the terminal (washing machine) is briefly illustrated from the viewpoint of the DM client and may be varied according to manufacturer.

A DM client application is implemented according to washing machine environment.

A DM daemon application is involved in operation of the DM client to process messages of the DM server or exceptions of the DM client.

An interface layer is a layer for interface between the DM client and DM daemon and may be implemented by a developer such that the interface layer conforms to standards using a shared library.

A base platform I/F is an interface for acquiring washing machine information least necessary for the DM server, DM client and DM daemon.

A firmware I/F is an interface for firmware update.

A control I/F is an interface for control of the washing machine.

A software I/F is an interface for management of software of the washing machine (washing course content file update management).

A DiaMon I/F (diagnosis/monitoring) is an interface for diagnosis/monitoring of the washing machine.

An OS platform is an operating system on which the DM client/DM daemon of the washing machine is installed. The OS may be Linux.

An upgrade agent is an agent for updating firmware of the washing machine and may be implemented to be adapted to a terminal according to the manufacturer of the terminal.

Washer/dryer hardware is hardware of the washing machine and may be divided into Wi-Fi USB, LCD, etc.

1) Washing Machine Management

Washing machine management services are shown in the following table.

TABLE 1

| DM service | | Washing machine (Embedded Linux) |
|---|---|---|
| Firmware update | | Update package size: about 40 MB. |
| | | Update package configuration: tar archive |
| | | (display part binary + microcomputer |
| | | binary). |
| | | Operation method |
| | | an update file is written to a file system |
| | | before restarting and then restarting is |
| | | performed. |
| | | an update result is transmitted to the DM |
| | | client before restarting. |
| | | Initiation method: DM server |
| Software management | | Course file management of washing course |
| (including content) | | management software (pre-loaded). |
| | | Content data form: one package file is |
| | | managed (about 1 KB or less per file). |
| | | Initiation method: DM server, terminal |
| | | (selected through LCD screen) |
| Terminal control | | Washing machine power On/Off. |
| management | | Washing machine operation On/Off. |
| | | Initiation method: DM server |
| Terminal | Diagnosis | One-time generation of diagnostic data. All |
| diagnosis/ | | data is stored in a DB. |
| monitoring | | A smartphone delivers updated data only. |
| management | | Initiation method: smartphone, terminal |
| | | (LCD) |
| | Monitoring | Multiple generations of operation status |
| | | information. |
| | | Only updated information is stored in DB. |
| | | Initiation method: smartphone |

2) Interoperation of Applications

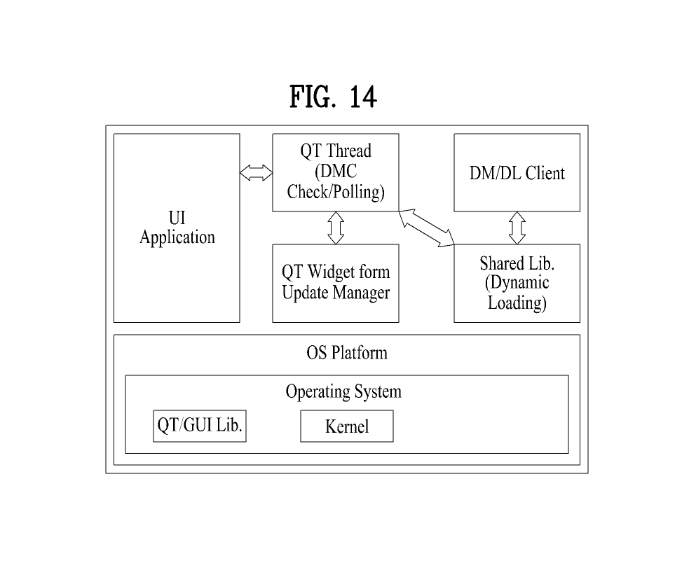

Interoperation of applications for terminal control is illustrated in FIG. 14. The DM client performs terminal management through a shared library and the terminal manufacturer needs to implement the shared library.

3) It is necessary to secure normal operations of the DM client/DM daemon by implementing an API according to API standards for terminal management. Particularly, the DM client/DM daemon are preferably installed as root. It is preferable that the DM daemon be executed at all times upon system booting of the terminal.

4) API Configuration

A description will be given of an API for interface between the embedded

Linux system and DM client/DM daemon of the washing machine.

4-1) The Following Functions can be Used as an API for Checking Fundamental Information of the Washing Machine.

getDMcPath: a function for acquiring a path of a file used in the DM client and obtaining a default directory path (absolute path) used by the DM client. This path is a place where DM client related files are located and is preferably readable/writable. Preferably, the path is maintained irrespective of system initialization, firmware update, terminal rebooting, etc.

getDMcFreeSize: a function for acquiring a currently available size of a file path used in the DM client.

getDeviceId: a function for acquiring a unique ID of a management target terminal.

getDeviceType: a function for acquiring the type of the management target terminal.

getManufact: a function for acquiring information on the manufacturer of the management target terminal.

getModelName: a function for acquiring the model name of the management target terminal. This may be a general model name used after the terminal is put on the market.

getLanguage: a function for acquiring a language used for the management target terminal.

getSoftwareVer: a function for acquiring a system software (OS) version of the management target terminal.

getHardwareVer: a function for acquiring a system hardware version of the management target terminal.

getOEM: a function for acquiring OEM information about the management target terminal.

4-2) Firmware Update Related API

getFirmwareVer: a function for acquiring a system firmware version of a smart appliance.

getFirmwarePath: a function for acquiring a path through which a firmware data file for firmware update is stored. This path refers to an absolute path of a file system through which firmware data is stored. The DM client stores downloaded firmware data through the path. It is preferable to maintain a firmware data file in this path because the DM client downloads firmware and verifies a package error before firmware update is requested.

getFirmwareFreeSize: a function for acquiring a currently available size of a firmware data storage path for firmware update.

setFirmwareTotalSize: a function for setting a total size of firmware data to be downloaded. This function can be used when a progress bar is represented through a GUI of the terminal.

setFirmwareCurSize: a function for setting a size of downloaded firmware data. This function is called whenever downloaded data is stored. To prevent frequent UI calling, the function is called only when a calling period is 500 ms or longer (the function is called irrespective of the calling period when download is ended). This function can be used when a progress bar is represented through the GUI of the terminal.

runFirmwareUp: a function for running a firmware update agent to perform firmware update. When the DM client calls this function, the function needs to be immediately returned. Since a DM client process is ended immediately after return of the function, firmware update can be performed. Firmware data is transmitted as a file and this file is deleted by the update agent after update. Upon completion of firmware update, a DM client process is performed to request firmware update result delivery.

setFirmwareProcessState: a function for delivering causes of network failure, server connection failure, etc. during firmware update. This function can be used when a progress bar is represented through the GUI of the terminal.

4-3) API for Control

An API for controlling the washing machine may include the following functions.

runPowerOff: a function for power off of a smart appliance. This function is immediately returned before power off.

getPowerState: a function for acquiring power state.

setPowerState: a function that is not used by the DM client and is used to store power state.

getOperationState: a function for acquiring an operation state.

setOperationState: a function for setting an operation state. Operation states can be categorized into “operating” and “interrupt”.

startOperation: a function for driving a terminal.

stopOperation: a function for stopping operation of the terminal.

4-4) API for Software Management

For example, an API for changing washing course setting is present.

setWasherCourse: a function for delivering a washing machine course setting file to change washing course setting. This function is called after the DM client downloads the washing machine course setting file, and the file name includes an absolute path.

4-5) Terminal Diagnosis/Monitoring Related API

startDiagMon: a function for requesting start of diagnosis/monitoring. Diagnosis/monitoring is performed by a diagnosis/monitoring application. This function is returned immediately after execution of the diagnosis/monitoring application. The diagnosis/monitoring application directly transmits diagnosis/monitoring data to the report server. However, when diagnosis is carried out through the display of the terminal, the DM client performs diagnosis without transmitting diagnosis/monitoring data to the report server.

stopDiagMon: a function for requesting diagnosis/monitoring to be stopped.

getDiagMon: a function for acquiring operation state information of diagnosis/monitoring.

setDiagMon: a function for setting operation state information of diagnosis/monitoring. The operation state information may include “operating” and “no operation”.

getDiagMonData: a function for acquiring diagnosis/monitoring data. Data regarding a result of diagnosis/monitoring performed by the diagnosis/monitoring application is acquired. Data regarding a result of final diagnosis/monitoring is preferably acquired as diagnosis/monitoring data.

5) DM Client Providing Interface

The DM client is provided as an application and the following interfaces are provided such that the DM client can be executed as a process at the request for DM daemon or firmware result delivery, washing course and diagnosis result delivery, etc.

5-1) Firmware Result Delivery Request

This is a method for delivering a firmware update result to the DM client. For firmware management, a firmware update result needs to be delivered to the server. For this, a DM client execution file needs to be executed upon completion of update (that is, the DM client process needs to be performed). After execution of the DM client, the system is not ended until the DM client is ended such that the result can be normally delivered to the DM server.

5-2) Firmware Start Request

This is a method by which a smart appliance requests firmware update to the DM client.

Upon request of firmware update through the display of the washing machine, if firmware to be updated is present in the server, the DM client execution file is executed to download the firmware.

After execution of the DM client, the system enters a standby state until the DM client is ended such that a firmware update package can be normally delivered from the DM server. Upon download of the firmware update package, the DM client notifies download of the firmware update package.

5-3) Washing Course Request

This is a method for requesting the DM client to update a washing course of the washing machine.

When washing course update is requested through the display of the washing machine, if a washing course to be updated is present in the server, the DM client execution file is executed to download the washing course upon request of washing course update through the display.

After execution of the DM client, the system enters a standby state until the DM client is ended such that the washing course can be normally delivered from the DM server. Upon download of the washing course, the DM client delivers washing course setting.

5-4) Diagnosis Result Delivery Request

This is a method for requesting a diagnosis result or monitoring alert of the terminal to be delivered to the DM client.

This can be used when diagnosis is requested through the LCD of the terminal or monitoring alert is notified.

When the terminal requests diagnosis, the DM client execution file is executed upon completion of diagnosis in order to deliver the diagnosis result.

When monitoring alert is generated in the terminal, the DM client execution file is executed upon completion of monitoring in order to transmit the monitoring result.

When the DM server requests diagnostic data, data can be requested by the DiagMonData ( ) function.

After execution of the DM client, the system does not exit until the DM client exits such that a result can be normally delivered to the DM server.

(2) Refrigerator—Interface among an embedded system, the DM client and DM daemon

A method of interfacing the embedded system and DM client/DM daemon of the refrigerator is briefly described.

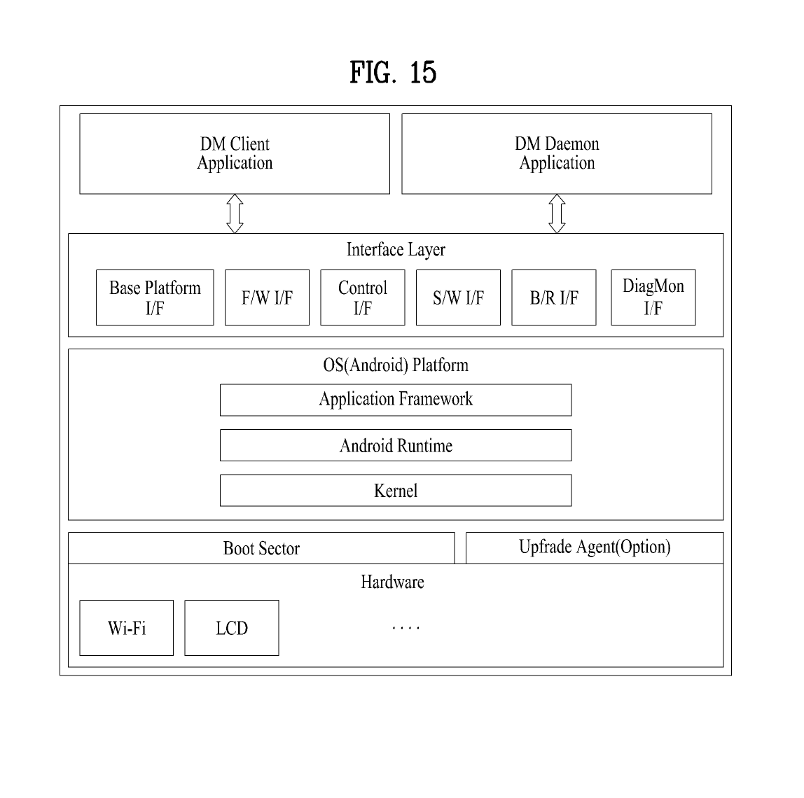

A hierarchical structure of the embedded system including the DM client/DM daemon of the refrigerator is shown in FIG. 15.

The structure of the terminal is briefly illustrated from the viewpoint of the DM client and may be varied according to manufacturer.

A DM client application is implemented according to refrigerator environment.

A DM daemon application is involved in operation of the DM client to process messages of the DM server or exceptions of the DM client.

An interface layer is a layer for interface between the DM client and DM daemon and uses a library.

A base platform I/F is an interface for acquiring refrigerator information least necessary for the DM server, DM client and DM Daemon.

A firmware I/F is an interface for firmware update.

A control I/F is an interface for control of the refrigerator.

A software I/F is an interface for management of software of the refrigerator. For example, this can be used for recipe content file update management.

Backup/Restore I/F is an interface for restoring/backing up food list or shopping list data.

A DiaMon I/F (diagnosis/monitoring) is an interface for diagnosis/monitoring of the refrigerator.

An OS platform is an operating system in which the DM client/DM Daemon of the refrigerator are installed. The OS may be Android.

An upgrade agent is an agent for updating firmware of the refrigerator.

Refrigerator hardware is hardware of the refrigerator and may be divided into Wi-Fi USB, LCD, etc.

1) Refrigerator Management

The DM server and DM client interoperate to process DMS services. Refrigerator management services are shown in the following table.

TABLE 2

| DM service | Refrigerator (Android) |
|---|---|
| Firmware update | Update package size: about 150 MB. |
| | An update package is configured as an image file. |
| | Operation method |
| | update is processed in a recovery mode after |
| | restarting. |
| | an update result is transmitted to the DM client |
| | after final update. |
| | Initiation method: DM server, terminal (LCD) |
| Software | Recipe file management of recipe management |
| management | software (pre-loaded) |
| (including | Content data form: one package file or each file |
| content) | (a file size is ~10 MB, total packet file size |
| | is about 500 MB, content data is composed of an |
| | access file and an image file) |
| | Initiation method: smartphone, terminal (LCD) |
| Terminal control | Refrigerator temperature control: cooling, freezing, |
| management | special freezing control, operation mode control, |
| | dispenser control |
| | Initiation method: smartphone |
| Terminal | Further model is scheduled. |
| diagnosis/ | Remark: independent diagnosis function is executed |
| monitoring | through terminal LCD |
| management | |
| Backup/Restoration | Food/shopping list management. |
| management | The terminal and smartphone interoperate but data |
| | is managed by the DM server only (only final data |
| | is managed). |
| | Initiation method: smartphone, terminal (LCD) |

2) Class Configuration

Classes for interface between the refrigerator (Android system) and the DM client/DM daemon are described.

2-1) Exception Class

An exception class for the DM client is defined.

a. DevicePortingException class: exception is sent to a part that calls a method of the class through DevicePortingException class upon generation of exception in the method.

b. Exception cause character string: this is a basic value used for a character string that describes the cause for exception of DevicePortingExeption class when exception is generated and uses a character string capable of recognizing exception.

2-2) DMS Class

This is a class that needs to be provided for DM client operation.

2-2-1) CSystemTools Class

This describes a class necessary for the DM client to operate.

CSystemTools: a constructor of CSystemtools

getDMcPath: a function for acquiring a directory path through which files used by the DM client are located. This is a function for obtaining a default directory path (absolute path) used by the DM client. This path corresponds to a place where DM client related files are located and is readable/writable. This path is maintained irrespective of system initialization, firmware update, smart home appliance rebooting, etc.

setClientState: a function for delivering operation state of the DM/DL client. The value of this function needs to be checked using intent in “DM client providing intent standard” which will be described later before the DM client is executed. This is for the purpose of preventing execution of the DM client from being requested through the display and daemon of the terminal when the DM client is operating. The DM/DL client calls this function at a time defined by the standard and informs the terminal of the time. That is, the state of the terminal can be checked only at the defined time.

2-2-2) CDeviceDetail Class (Smart Appliance Information Acquisition)

Classes for acquiring information on smart appliances are described.

CDeviceDetail: a constructor of CDeviceDetail.

getDeviceId, getDeviceType, getManufact, getModeName, getLanguage, getFirmwareVer, getSoftwareVer, getHarewareVer and getOEM functions are included.

2-2-3) CFumoTools Class (Firmware Update)

Classes for firmware update are described.

CFumoTools: a constructor of CFumoTools.

getState: a function for acquiring firmware update state.

setState: a function for setting firmware update state. The DM client sets a parameter state to a value in the range of 10 to 50 and UA (firmware update agent) sets 80 or 100. The DM client sets the parameter state to 50 when the DM client wants to start update. The UA checks the parameter state when the terminal is rebooted and updates firmware when the parameter state is 50.

getResultCode: a firmware update result code. setResultcode: a function for setting a firmware update result as a FUMO result code. Upon system rebooting, the DM client checks and delivers the firmware update result.

The classes for firmware update may further include getFirmwarePath, getFirmwareFreeSize, setFirmwareTotalSize, setFirmwareCurSize, setFirmwareProcessState and runFirmwareUp functions.

2-2-4) CControlTools Class (Control)

Classes for controlling the refrigerator are described.

CControlTools: a constructor of CControlTools

setTemperature: a function for setting temperatures of the refrigeration compartment and freezer of the refrigerator.

getTemeprature: a function for acquiring temperatures of the refrigeration compartment and freezer of the refrigerator.

setIcePlus: a function for setting special freezing of the refrigerator. Special freezing on or off can be set through this function. In addition, special freezing off and fast freezing off, special freezing on and fast freezing off, and special freezing off and fast freezing on can be set through this function.

getIcePlus: a function for acquiring special freezing set state of the refrigerator.

setOperation: a function for setting an operation mode of the refrigerator. Operation modes of the refrigerator may be categorized into a normal mode, a test mode, an LQC mode, a display mode and smart diagnosis.

getOperation: a function for acquiring operation mode state of the refrigerator.

setDispenser: a function for setting a dispenser state of the refrigerator. Dispenser states of the refrigerator can be categorized into crushed ice state, water state and ice cube state.

getDispenser: a function for acquiring a dispenser state of the refrigerator.

setHygienefilter: a function for setting a hygiene filter state of the refrigerator. Hygiene file states can be categorized into an off state, auto state, power state and replacement, etc.

getHygieneFilter: a function for acquiring a hygiene filter state of the refrigerator.

setFullIceDetect: a function for setting a full ice state of the refrigerator. Full ice states of the refrigerator can be divided into a normal state and a full ice state.

getFulllceDetect: a function for acquiring a full ice state of the refrigerator.

setIceMaker: a function for setting an icemaker state of the refrigerator. For example, this function can set an icemaker on or off state.

getIceMaker: a function for acquiring an icemaker state of the refrigerator.

setBlasterChiller: a function for setting a blaster chiller state of the refrigerator. This function can set on or off state of a blaster chiller.

getBlasterChiller: a function for acquiring a blaster chiller state of the refrigerator.

2-2-5) CScomoTools Class (Recipe Content Management)

Classes for software content management are described.

CScomoTools: a constructor of CScomoTools

getRecipeVer: a function for acquiring a recipe version.

getReceipePath: a function for acquiring a directory path through which a recipe package is stored. This function is used to directly download a recipe file through the path because the recipe file may have a large file size.

getRecipeFreeSize: a function for acquiring a size of a region in which a recipe file is stored.

setRecipeTotalSize: a function for setting a total size of a recipe file to be downloaded. This function can be used when a progress bar is represented through a GUI of the refrigerator.

setRecipeCurSize: a function for setting a size of a downloaded recipe file. This function is called whenever downloaded data is stored. To prevent frequent UI calling, the function is called only when a calling period is 50 ms or longer. The function is called irrespective of the calling period when download is completed. This function can be used when a progress bar is represented through the GUI of the terminal.

setRecipeProcessState: a function for transmitting the cause of network failure, server connection failure, etc. while a recipe is used. This function can be used to process exception when a progress bar is represented through the GUI of the terminal.

setRecipeDowncomplete: a function for informing a recipe management application of completion of download upon download of a recipe data file. The DM client downloads recipe data through a confirmed path of getRecipePath( ) and calls this function. Upon calling of this function, the recipe management application applies the recipe data file transmitted thereto as necessary.

2-2-6) CBackupRestoreTools Class (Food/Shopping List Management)

Classes for backup/restoration of a food list or shopping list are described.

CBackup/RestoreTools: a constructor of CBackupRestoreTools

getDataFile: a function for acquiring the name of a file in which a food/shopping list is stored.

setDataFile: a function for transmitting a downloaded food/shopping list data file. The function transmits a file name including a path of the downloaded food/shopping list data file.

resultInfo: a function for transmitting the state of an uploaded/downloaded food/shopping list data file.

2-2-7) CDiagMonTools Class

Classes for diagnosis/monitoring are described.

CDiagMonTools: a constructor of CDiagMonTools

The classes for diagnosis/monitoring may include functions such as startDiagMon, stopDiagMon, getDiagMonState, getDiagMonData, etc.

3) DM Client Providing Intent Standard

The DM client is provided as an application and provides the following interfaces such that the DM client can be executed as a process at the request for DM daemon or firmware result delivery, diagnosis result delivery, backup/restoration, etc.

To prevent DM client operation from being requested through the display of the terminal during operation of the DM client, getClientState is checked and then intent is used.

3-1) Food/Shopping List Backup Request

This is a method of using intent to request the DM server to back up food/shopping list data of the refrigerator. Upon request of backup, the DM client requests file information to be backed up to getDataFile( ) of CBackupRestoreTools class.

3-2) Food/Shopping List Restoration Request

This is a method of using intent to retrieve food/shopping information of the refrigerator from the DM server. Upon request of restoration, the DM client delivers the path of a file downloaded to setDataFile( ) of CBackupRestoreTools to a food/shopping list management application.

3-3) User Firmware Update Request

This is a method of using intent to interoperate with the DM client when the user requests firmware update through the terminal.

After the DM client is executed, whether update is performed or not is determined according to a firmware version of the DM server, that is, a firmware version checked according to getFirmwareVer( ) function. If the DM server has an update, update is performed. Upon checking of firmware update (upon confirmation of the result of setFirmwareProcessState), confirmation of whether recipe update is performed or not is requested.

3-4) Recipe Download Request

This is a method of using intent to interoperate with the DM client when the user requests a selected recipe to be downloaded through the terminal.

A recipe item selected by the user from a plurality of items of a recipe metadata file downloaded from the DM server is downloaded. Upon checking of recipe update (upon confirmation of the result of setRecipeProcessState), confirmation of whether firmware update is performed or not is requested.

3-5) Diagnosis Completion Signaling

This is a method of using intent to interoperate with the DM client when the user requests diagnosis of the terminal.

The diagnosis agent executes the DM client upon completion of collection of diagnostic data of the smart appliance. The DM client brings a diagnostic data file to getDiagMonData( ) of CDiagMonTools to transmit the diagnostic data file to the server.

4) DiagMon Data Transmission Method

The diagnosis/monitoring agent of the terminal receives a report server URI from the DM client, collects data and transmits the data to the report server.

The data includes the following.

Device ID: a unique value of the terminal.

Model name: the model name of the terminal.

ID: ID transmitted to the diagnosis/monitoring agent of the terminal when the DM server requests DiagMon agent to be started (DM client refers to a correlator value with respect to DiagMon initiation).

DevType: terminal type code. For example, 101: refrigerator, 202: washing machine, 202: dryer.

301: electric oven.

Trigger: a value indicating whether diagnosis/monitoring is started by the DM server or the terminal (this value is generated through LCD or alert of the terminal).

DiagMonType: a value for discriminating diagnostic data from monitoring data.

DiagMon Data: actual diagnosis/monitoring data.

1. A terminal management system comprising:
a server to which a user ID and a password generated through a user website are input; and
a terminal for transmitting a device ID thereof and the user ID and password (user information) input by a user to the server,
wherein the server matches the user ID with the device ID (terminal information) and provides a management service to the terminal at the request of the terminal for the management service.

2. The terminal management system according to claim 1, wherein the terminal is registered in the server using the user ID, password and device ID provided by the terminal.

3. The terminal management system according to claim 2, wherein the device ID is previously input to the terminal or automatically generated.

4. The terminal management system according to claim 3, wherein the device ID is generated in a communication connection procedure prior to registration of the terminal in the server.

5. The terminal management system according to claim 1, wherein the terminal corresponds to home appliances including at least one of a washing machine, a dryer, a refrigerator, a vacuum cleaner and an electric oven.

6. The terminal management system according to claim 5, wherein the terminal includes a user interface configured to request the server to provide a management service,
wherein the user ID and password are input through the user interface.

7. The terminal management system according to claim 1, wherein the server comprises:
a user website server for providing the user website; and
a DM server for issuing a management command to provide a management service to the terminal.

8. The terminal management system according to claim 7, wherein the terminal provides the device ID and the user ID and password (user information) input by the user to the user website server, and the user website server matches the user ID with the device ID and registers the matched user ID and device ID.

9. The terminal management system according to claim 8, wherein the DM server authenticates and registers the user information and terminal information provided by the user web site server.

10. The terminal management system according to claim 7, wherein the server comprises:
a DL server providing a function of downloading a file in the terminal; and
a notification server providing a notification message of the DM server to the terminal.

11. The terminal management system according to claim 7, wherein the terminal comprises:
a communication module for communicating with the server;
a DM client executing a management command of the DM server; and
a daemon by which the terminal periodically accesses the server.

12. The terminal management system according to claim 11, wherein the communication module is a WiFi communication module and the terminal is linked to the server through a wireless sharing router (AP).

13. The terminal management system according to claim 12, wherein the wireless sharing router provides IP information thereof and information on a port to which the terminal is connected to the server.

14. The terminal management system according to claim 7, further comprising a mobile communication terminal requesting the server to provide a management service for the terminal through an open application programming interface (API) of the server.

15. A terminal management method comprising:
storing a user ID and a password (user information) in a server;
transmitting a device ID of a terminal and the user ID and password input to the terminal to the server such that the terminal is authenticated and registered in the server; and
after receiving a management service request from the terminal, providing the requested management service to the terminal by the server.

16. The terminal management method according to claim 15, wherein the management service request is received from a mobile communication terminal instead of the terminal.

17. The terminal management method according to claim 15, wherein the terminal includes a WiFi communication module connected to a wireless sharing router (AP),
wherein the wireless sharing router provides IP information thereof and information on a port to which the terminal is connected to the server.

18. Home appliances comprising:
a WiFi communication module connected to a server through a wireless sharing router; and
a user interface configured to request the server to provide management services,
wherein a device ID of a terminal and a user ID and a password input by a user through the user interface are transmitted to the server when the management services are requested.

19. The home appliances according to claim 18, wherein the home appliances include a washing machine,
wherein the management services include at least one of firmware update, software update, remote control of the washing machine and diagnosis or monitoring of the washing machine.

20. The home appliances according to claim 18, wherein the home appliances include a refrigerator,
wherein the management services include at least one of firmware update, software update, remote control of the refrigerator, food/shopping list management and diagnosis or monitoring of the refrigerator.
